(19) United States
(12) Patent Application Publication
(10) Pub. No.: US 2009/0322681 A1
(43) Pub. Date: Dec. 31, 2009

(54) Mouse and computer system using the same

(75) Inventor: Chih-Yi Wang, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: Wistron Corporation, Taipei Hsien (TW)

(21) Appl. No.: 12/314,097

(22) Filed: Dec. 4, 2008

(30) Foreign Application Priority Data
Jun. 30, 2008 (TW) 097124617

(51) Int. Cl. G06F 3/033

(52) U.S. Cl. 345/163

(57) ABSTRACT

A computer mouse is disclosed. The computer mouse comprises a main body, a transmission line set, a speaker module, and an electro therapy device. The speaker module and the electro therapy device are disposed in the main body. The speaker module comprises at least three channels to output audio signals transmitted from the computer. The electro therapy device is capable of providing the function of electro therapy. A computer is connected to the mouse via the transmission line set for transmitting signals and supplying power to the speaker module and the electro therapy device.

### BACKGROUND OF THE INVENTION

1. Field of the Invention

The present invention relates to a mouse and, more particularly, to a mouse with a multi-channel speaker and an electro therapy function.

2. Description of the Related Art

Currently, the computer mouse is an essential tool when a user uses a computer. Take a notebook computer as an example; in order to facilitate operations of the notebook computer, many users prepare an additional mouse for external use. However, a general mouse only has simple operating functions. For a notebook computer equipped with a mouse function, the external mouse with a single function is relatively impractical and unbeneficial. In fact, other than the space used for installation of elements to achieve the common operating functions, there is still a lot of unused space within the mouse, which leads to a waste of usage space. Further, as users gradually increase their time of using computers, hand or wrist injuries may develop due to a long-time mouse operation. Therefore, there is a need to provide an improved design for a mouse so as to improve comfort over long durations of operation.

Therefore, there is a need to provide a mouse and a computer system using the same to mitigate and/or obviate the aforementioned problems.

### SUMMARY OF THE INVENTION

It is an object of the present invention to provide a mouse with a multi-channel speaker and an electro therapy function.

To achieve the aforementioned object, the mouse of the present invention is electronically connected to a computer. The mouse of the present invention comprises a main body, a transmission line set, a speaker module, and an electro therapy device. The speaker module and the electro therapy device are disposed in the main body. The speaker module comprises at least three channel outputs. Audio signals transmitted from the computer can be outputted via the speaker module so as to provide a stereo output effect. The electro therapy device provides an electro therapy effect. The transmission line set is used for connecting the mouse and the computer so as to transmit signals and supply power to the speaker module and the electro therapy device. Accordingly, the electro therapy function of the mouse of the present invention helps to alleviate discomfort of a user's wrist or hand by means of massage. Furthermore, the placement position of the mouse of the present invention can be freely adjusted so as to achieve the best audio effect.

A computer system of the present invention comprises a computer main body and the aforementioned mouse. The mouse is electronically connected to the computer main body. The computer main body comprises a speaker set. The computer system of the present invention forms a multi-channel output system by combining the speaker set and the speaker module of the mouse, so as to achieve a 5.1-channel or higher multi-channel sound effect. Furthermore, by means of the electro therapy device, the electro therapy effect can be provided to a user's wrist or hand.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1(a) illustrates a structural perspective drawing a mouse of the present invention.

FIG. 1(b) illustrates a schematic drawing of an electro therapy device of the mouse of the present invention.

FIG. 2 illustrates a structural schematic drawing of the mouse of the present invention.

FIG. 3 illustrates a schematic drawing of a computer system of the present invention.

### DETAILED DESCRIPTION OF THE PREFERRED EMBODIMENT

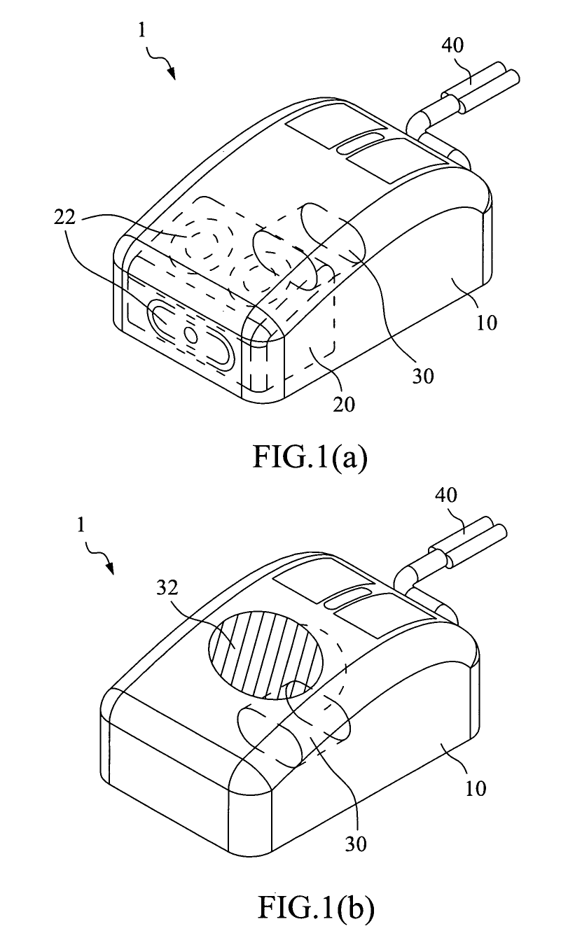

Please refer to both FIG. 1(a) and FIG. 1(b). FIG. 1(a) illustrates a structural perspective drawing a mouse of the present invention. FIG. 1(b) illustrates a schematic drawing of an electro therapy device of the mouse of the present invention. The mouse 1 of the present invention is electronically connected to a computer (not shown in figures). As shown in FIG. 1(a), the mouse 1 of the present invention comprises a main body 10, a transmission line set 40, a speaker module 20, and an electro therapy device 30. The speaker module 20 and the electro therapy device 30 are disposed in the main body 10. The speaker module 20 comprises at least three channel outputs 22. Audio signals transmitted from the computer can be outputted via the speaker module 20. In this embodiment, the speaker module 20 is in the form of a sound box, which can provide good sound resonance to improve the sound output quality. Further, according to the design of the at least three channel outputs 22, each channel output can output sound at different sound ranges, such that the speaker module 20 can generate a stereo output effect.

As shown in FIG. 1(b), the electro therapy device 30 can comprise a conductive portion 32, which is disposed to the surface of the main body 10. Therefore, when the electro therapy device 30 is activated, current is transmitted to the conductive portion 32. As a result, when a user holds the main body 10, the user will contact the conductive portion 32, such that the electro therapy effect is thereby generated. The conductive portion 32 can also have protrusions for massaging acupuncture points of the user's hand or wrist so as to enhance the electro therapy effect. The transmission line set 40 is used for connecting the mouse 1 and the computer (not shown in figures) so as to transmit signals and supply power to the speaker module 20 and the electro therapy device 30 of the mouse 1. According to the aforementioned design, the electro therapy function of the mouse of the present invention helps to alleviate discomfort of the user's wrist or hand by means of massage. Furthermore, the placement position of the mouse of the present invention can be freely adjusted so as to achieve the best audio effect.

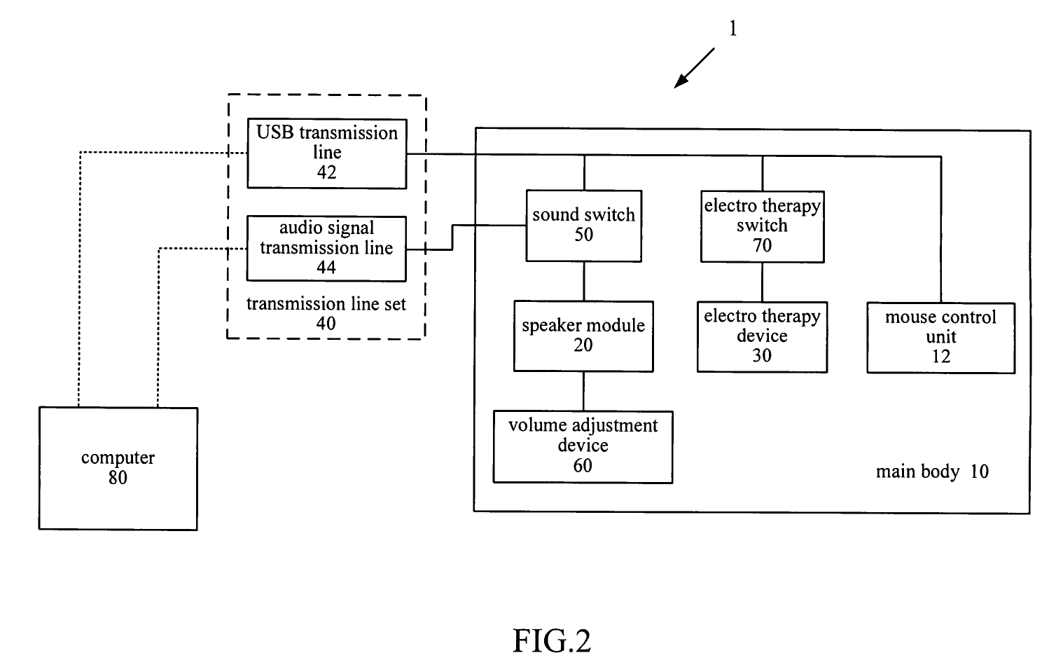

Please refer to FIG. 2, which illustrates a structural schematic drawing of the mouse 1 of the present invention. As shown in FIG. 2, the main body 10 of the mouse 1 of the present invention is installed with a mouse control unit 12, a speaker module 20, and an electro therapy device 30. The mouse control unit 12 is used to execute cursor control functions of the mouse 1 itself. One end of the transmission line set 40 is connected to the main body 10, and the other end has a corresponding terminal structure for being correspondingly connected to an input port (not shown in FIG. 2) of the computer 80. In this embodiment, the transmission line set 40 comprises a universal serial bus (USB) transmission line 42 and an audio signal transmission line 44 for respectively connecting to a USB port and an audio signal output port of the computer 80. The computer 80 supplies power to each element of the mouse 1 via the USB transmission line 42. Meanwhile, the mouse 1 and the computer 80 can also transmit command signals via the USB transmission line 42 to execute operations of the mouse itself. In order to enhance the sound effect, the present invention utilizes the additional audio signal transmission line 44 to transmit audio signals transmitted from the computer 80, and then outputs the audio signals via the speaker module 20. In this embodiment, the audio signal transmission line 44 is a Sony/Philips digital interface format (SPDIF) transmission line for providing a better audio effect. However, please note that the audio signal transmission line can be a general audio cable or other kinds of audio signal transmission lines without being limited to the aforementioned embodiment.

The mouse 1 of the present invention further comprises a sound switch 50 and a volume adjustment device 60, wherein both are electronically connected to the speaker module 20. The sound switch 50 is used for controlling a power on/off switch of the speaker module 20. The volume adjustment device 60 is used for adjusting the volume outputted from the speaker module 20. Furthermore, the mouse 1 of the present invention further comprises an electro therapy switch 70, which is electronically connected to the electro therapy device 30. The electro therapy switch 70 is used for controlling a power on/off switch of the electro therapy device 30.

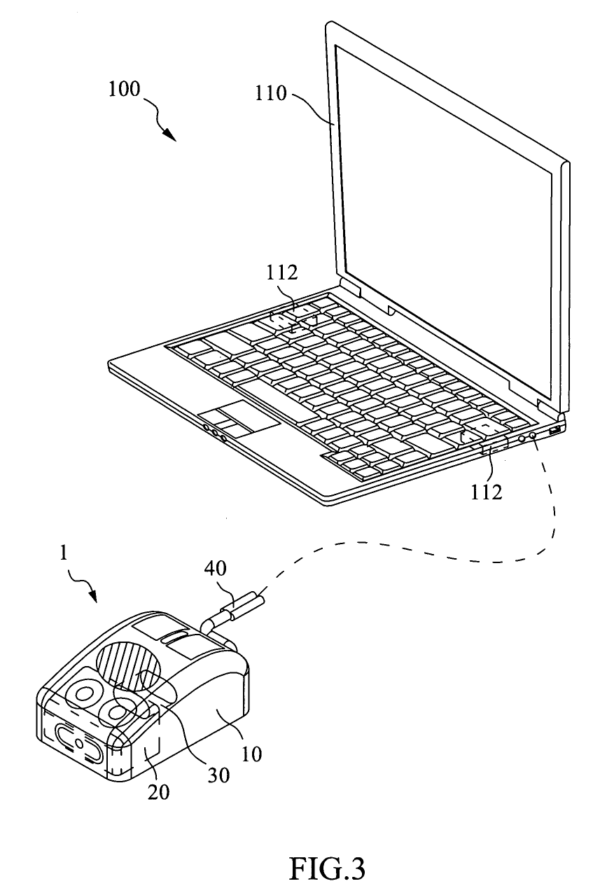

Please refer to FIG. 3, which illustrates a schematic drawing of a computer system 100 of the present invention. As shown in FIG. 3, a computer system 100 of the present invention comprises a computer main body 110 and the aforementioned mouse 1. The mouse 1 is electronically connected to the computer main body 110. The computer main body 110 comprises a speaker set 112, which is used for outputting audio signals generated by the computer main body 110. The computer system 100 of the present invention utilizes two channel outputs of the speaker set 112 as right rear and left rear stereo channels, and utilizes the at least three channel outputs provided by the speaker module 20 of the mouse 1 as front stereo channels and one independent center channel; further, the present invention sets a sub-woofer channel, so as to form a multi-channel output system, thereby achieving a 5.1-channel or higher multi-channel sound effect. The placement position of the mouse 1 can be freely adjusted according to the current situation or a user's requirement, such that the mouse 1 becomes a movable sound output device so as to achieve the best sound effect. In this embodiment, the computer main body 110 is a notebook computer. However, the computer main body 110 can also be other portable computer devices or desktop computers without being limited to the aforementioned embodiment. Furthermore, by means of the electro therapy device 30 disposed in the mouse 1, the computer system 100 of the present invention can provide the electro therapy effect when the user is using the mouse 1 so as to alleviate discomfort upon operation as well as to reduce the possibility of causing disorders such as Repetitive Stress Disorder.

Although the present invention has been explained in relation to its preferred embodiments, it is to be understood that many other possible modifications and variations can be made without departing from the spirit and scope of the invention as hereinafter claimed.

What is claimed is:

1. A mouse electronically connected to a computer comprising:
a main body;
a speaker module disposed in the main body comprising at least three channel outputs, the speaker module outputting audio signals transmitted from the computer to provide a stereo output effect;
an electro therapy device, disposed in the main body, used for providing an electro therapy effect; and
a transmission line set, used for connecting the mouse and the computer, so as to transmit signals and supply power to the speaker module and the electro therapy device.

2. The mouse as claimed in claim 1, wherein the speaker module is in the form of a sound box.

3. The mouse as claimed in claim 1, wherein the transmission line set comprises a universal serial bus (USB) transmission line and an audio signal transmission line.

4. The mouse as claimed in claim 3, wherein the audio signal transmission line is a Sony/Philips digital interface format (SPDIF) transmission line.

5. The mouse as claimed in claim 1 further comprising a sound switch, electronically connected to the speaker module for controlling a power on/off switch of the speaker module.

6. The mouse as claimed in claim 1 further comprising a volume adjustment device, electronically connected to the speaker module for adjusting a volume outputted from the speaker module.

7. The mouse as claimed in claim 1 further comprising an electro therapy switch, electronically connected to the electro therapy device for controlling a power on/off switch of the electro therapy device.

8. A computer system, comprising:
a computer main body comprising a speaker set; and
a mouse electronically connected to the computer main body, the mouse comprising:
a main body;
a speaker module, disposed in the main body, the speaker module comprising at least three channel outputs, the speaker module outputting audio signals transmitted from the computer, wherein a multi-channel output system is formed by combining the speaker set and the speaker module;
an electro therapy device, disposed in the main body, used for providing an electro therapy effect; and
a transmission line set, used for connecting the mouse and the computer main body, so as to transmit signals and supply power to the speaker module and the electro therapy device.

9. The computer system as claimed in claim 8, wherein the speaker module is in the form of a sound box.

10. The computer system as claimed in claim 8, wherein the transmission line set comprises a USB transmission line and an audio signal transmission line.

11. The computer system as claimed in claim 10, wherein the audio signal transmission line is a SPDIF transmission line.

12. The computer system as claimed in claim 8, wherein the mouse further comprises a sound switch electronically connected to the speaker module for controlling a power on/off switch of the speaker module.

13. The computer system as claimed in claim 8, wherein the mouse further comprises a volume adjustment device electronically connected to the speaker module for adjusting a volume outputted from the speaker module.

14. The computer system as claimed in claim 8, wherein the mouse further comprises an electro therapy switch electronically connected to the electro therapy device for controlling a power on/off switch of the electro therapy device.
